(19) United States
(12) Patent Application Publication
(10) Pub. No.: US 2009/0097261 A1
(43) Pub. Date: Apr. 16, 2009

(54) MULTI-FUNCTION OPTICAL FILM AND POLARIZER

(75) Inventors: Wen-Jiunn Hsieh, Taipei County (TW); Wen-Tse Tseng, Taoyuan County (TW); Cheng-Min Liao, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taipei (TW)

(21) Appl. No.: 12/056,252

(22) Filed: Mar. 26, 2008

(30) Foreign Application Priority Data
Oct. 15, 2007 (TW) 96138501

(51) Int. Cl. G02B 5/02; F21V 9/14

(52) U.S. Cl. 362/355; 359/485

(57) ABSTRACT

A multi-function optical film including a substrate and an optical film is provided. The optical film is disposed on the substrate. The optical film includes a diffusion layer disposed on the substrate and a plurality of micro-protruding structures disposed on the diffusion layer in an array. Besides, the diffusion layer and the micro-protruding structures are formed by mixing a plurality of scattering particles and a transmissive material.

### CROSS-REFERENCE TO RELATED APPLICATION

This application claims the priority benefit of Taiwan application serial no. 96138501, filed on Oct. 15, 2007. The entirety the above-mentioned patent application is hereby incorporated by reference herein and made a part of specification.

### BACKGROUND OF THE INVENTION

1. Field of the Invention

The present invention relates to an optical film. More particularly, the present invention relates to a multi-function optical film.

2. Description of Related Art

Currently, the rapid development of multi-media technology relies much on the progress of semiconductor devices and display apparatus. For displays, LCDs, having advantages of a high image quality, optimal space utilization, low power consumption, and no radiation, have become mainstream produces in the market. Generally speaking, an ordinary LCD usually contains a component with color display function, for example, an LCD panel. As the LCD panel does not emit light itself, a backlight module must be arranged under the LCD panel for providing a plane light source, so as to make the LCD panel to display.

FIG. 1 is a schematic cross-sectional view of a conventional backlight module. Referring to FIG. 1, a conventional backlight module 100 is constituted by a light box 110, a plurality of light sources 120, and a diffuser 130. The light sources 120 are disposed in the light box 110, and the diffuser 130 is disposed on the light box 110. As the light sources 120 are usually point light sources or linear light sources, the brightness of the backlight module 100 may be not uniform. In order to make the backlight module 100 achieve a better optical effect, a diffuser 130 and a prism 140 are disposed. The diffuser 130 scatter the lights uniformly, and the prism 140 disposed on the diffuser 130 adjusts the directivity of the lights emerging from the diffuser 130.

However, the diffuser 130 and prism 140 are usually adhered with an additional adhesive material. The additional adhesive material may decrease the transmittance of the light. Besides, the more optical films are adhered, the more time of the whole process will be, and also the probability of rework may be greatly raised.

### SUMMARY OF THE INVENTION

Accordingly, the present invention is directed to a multi-function optical film, which is capable of scattering and gathering light, and is easy to adhere.

The present invention is further directed to a polarizer, which can be adhered repeatedly.

The present invention provides a multi-function optical film, which includes a substrate and an optical film. The optical film is disposed on the substrate. The optical film includes a diffusion layer disposed on the substrate and a plurality of micro-protruding structures disposed on the diffusion layer in an array. Besides, the diffusion layer and the micro-protruding structures are formed by mixing a plurality of scattering particles and a transmissive material.

In an embodiment of the present invention, the micro-protruding structures are in a shape of, for example, cube, cuboid, cylinder, or cone. A diameter of the micro-protruding structures is smaller than 10 μm, and a height thereof is smaller than 3 μm.

In an embodiment of the present invention, a material of the scattering particles includes glass beads.

In an embodiment of the present invention, the transmissive material is polymethyl methacrylate (PMMA) or polycarbonate (PC).

In an embodiment of the present invention, a material of the substrate is polyethylene terephthalate (PET).

The present invention further provides a polarizer, which includes a first film and a plurality of micro-protruding structures. The plurality of micro-protruding structures is vertically disposed on the first film.

In an embodiment of the present invention, the first film includes a protective layer and a polarizing body disposed on one side of the protective layer. The other side of the protective layer is bonded with the micro-protruding structures. Moreover, the protective layer and the micro-protruding structures are made of the same material. In other embodiments, the protective layer, the polarizing body, and the micro-protruding structures are made of the same material.

In an embodiment of the present invention, a diameter of the micro-protruding structures is smaller than 5 μm, and a height thereof is smaller than 3 μm.

The multi-function optical film of the present invention adopts the design of the micro-protruding structures, and the diffusion layer and the micro-protruding structures are formed by mixing a plurality of scattering particles and a transmissive material.

Due to the micro-protruding structures, the multi-function optical film of the present invention has the function of adjusting the directivity of the emitting light and scattering lights uniformly. Moreover, the polarizer of the present invention can be repeatedly adhered onto the surface of an object due to the micro-protruding structures.

In order to make the aforementioned and other objectives, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional backlight module.

FIG. 2 is a schematic view of a multi-function optical film of the present invention.

FIG. 3 is a schematic view of a polarizer according to a second embodiment of the present invention.

FIG. 4 is a schematic view of a polarizer according to a third embodiment of the present invention.

FIG. 5 is a schematic view of a polarizer according to a fourth embodiment of the present invention.

### DESCRIPTION OF EMBODIMENTS

### The First Embodiment

FIG. 2 is a schematic view of a multi-function optical film of the present invention. Referring to FIG. 2, the multi-function optical film 150 includes a substrate 160 and an optical film 170 disposed on the substrate 160. The material of the substrate 160 is, for example, PET. Particularly, the optical film 170 includes a diffusion layer 180 and a plurality of micro-protruding structures 190. Concretely, the diffusion layer 180 is disposed on the substrate 160, and the micro-protruding structures 190 are disposed on the diffusion layer 180 in an array.

In detail, the diffusion layer 180 and the micro-protruding structures 190 are formed by mixing a plurality of scattering particles S and a transmissive material T. Concretely, the scattering particles S may be glass beads, and the transmissive material T may be, for example, PMMA or PC.

In practice, the scattering particles S in the diffusion layer 180 scatter an incident light L_{I} in the transmissive material T. In detail, when the incident light L_{I} passes through the diffusion layer 180, as the refractive index of the transmissive material T is different from that of the scattering particles S, the incident light L_{I} may be consecutively refracted, reflected, and scattered in the two media, such that the incident light L_{I} may be scattered uniformly to obtain an emitting light L_{E} as shown in FIG. 2, thus achieving a more uniform display quality.

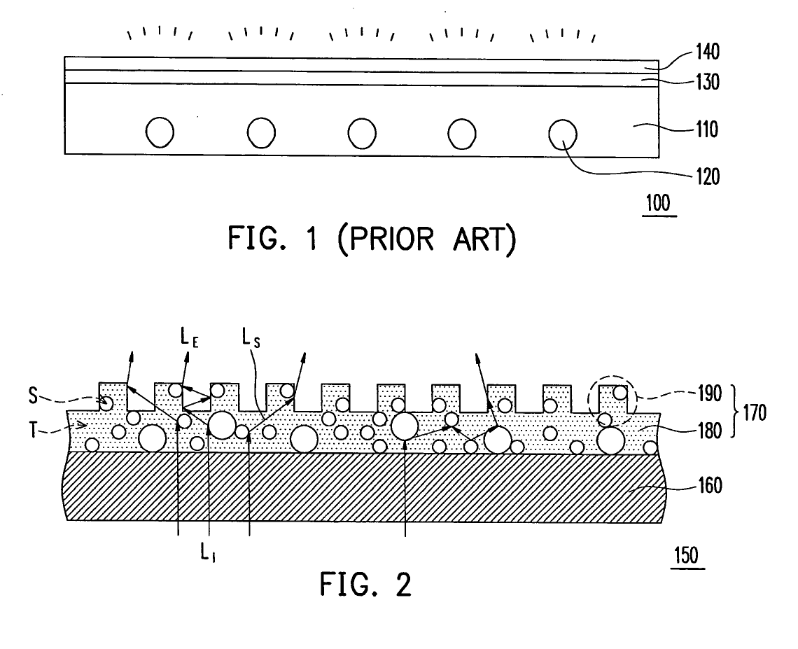

Particularly, the micro-protruding structures 190 are capable of gathering the emitting light L_{E}. A scattered light L_{S} passing through the diffusion layer 180 may be gathered by the micro-protruding structures 190 and then emitted. In this manner, the micro-protruding structures 190 may effectively enhance the brightness of the emitting light. In other words, the multi-function optical film 150 of the present invention has the both advantages of diffusing the light uniformly and gathering the emitting light L_{E}. Therefore, the multi-function optical film 150 of the present invention can substitute the conventional diffuser 130 and prism 140 (as shown in FIG. 1), and effectively simplifies the adhering process to reduce the probability of rework.

It should be emphasized that the scale of the micro-protruding structures 190 disposed on the diffusion layer 180 in an array is measured with a micrometer scale. In this embodiment, the micro-protruding structures 190 are, for example, cubes with a diameter smaller than 10 μm and a height smaller than 3 μm. In other embodiments, the micro-protruding structures 190 may also be in the shape of cuboid, cylinder, or cone.

As the size of the micro-protruding structures 190 and the distance between the micro-protruding structures 190 are measured with the micrometer scale, the multi-function optical film 150 of the present invention can be easily adsorbed onto the surface of an object, and can be adhered repeatedly. The multi-function optical film 150 of the present invention may be adhered onto the surface of an object without using additional adhesive materials, thereby enhancing the transmittance of the light. Furthermore, particles dropping on the micro-protruding structures 190 may be easily cleaned, thus easily getting rid of undesired foreign matters.

### The Second Embodiment

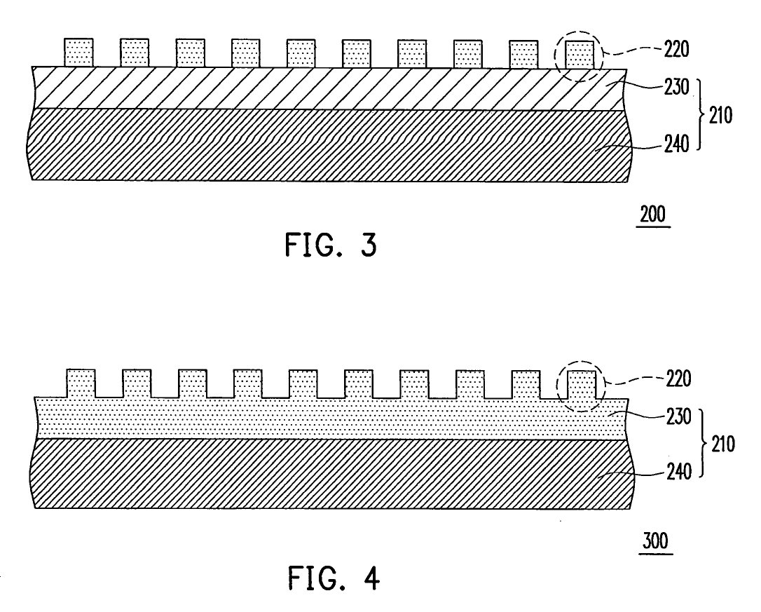

FIG. 3 is a schematic view of a polarizer according to a second embodiment of the present invention. Referring to FIG. 3, the polarizer 200 includes a first film 210 and a plurality of micro-protruding structures 220. The plurality of micro-protruding structures 220 is vertically disposed on the first film 210. The first film 210 includes a protective layer 230 and a polarizing body 240 disposed on one side of the protective layer 230. The other side of the protective layer 230 is bonded with the micro-protruding structures 220.

Similar to the first embodiment, the scale of the micro-protruding structures 220 is also measured by the micrometer scale. For example, the diameter of the micro-protruding structures 220 is smaller than 5 μm, and the height thereof is smaller than 3 μm. When the polarizer 200 is applied to a TFT-LCD, the plurality of micro-protruding structures 220 provides a certain adhesion for the polarizer 200 to be adhered onto the surface of a glass substrate, such that the polarizer 200 can be directly adhered onto the surface of the glass substrate without using additional adhesive materials. In another aspect, the plurality of micro-protruding structures 220 gather the light polarized by the polarizing body 240 and output the light to a display panel (not shown). With the micro-protruding structures 220, the polarizer 200 of this embodiment can be adhered repeatedly.

### The Third Embodiment

FIG. 4 is a schematic view of a polarizer according to a third embodiment of the present invention. Referring to FIG. 4, the polarizer 300 of this embodiment is similar to the polarizer 200 of the second embodiment, and the difference therebetween is described as following. In the polarizer 300 of this embodiment, the protective layer 230 and the plurality of micro-protruding structures 220 are made of the same material. The polarizer 300 of this embodiment has the same effect as the polarizer 200 of the second embodiment.

### The Fourth Embodiment

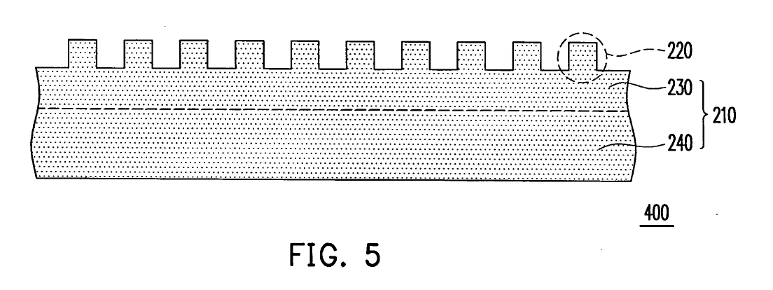

FIG. 5 is a schematic view of a polarizer according to a fourth embodiment of the present invention. Referring to FIG. 5, the polarizer 400 of this embodiment is similar to the polarizer 200 of the second embodiment, and the difference therebetween is described as follows. In the polarizer 400 of this embodiment, the protective layer 230, the polarizing body 240, and the plurality of micro-protruding structures 220 are made of the same material. The polarizer 400 of this embodiment has the same effect as the polarizer 200 of the second embodiment.

In view of the above, the multi-function optical film and polarizer of the present invention use the micro-protruding structures in micrometer scale, so can be adhered and repeatedly adhered easily. Limited by the heat durability of the polarizer, a display panel adhered with the polarizer is difficult to go through a laser repairing process. As the polarizer of the present invention is capable of being adhered repeatedly, the polarizer may be removed before performing the laser repairing on the display panel. Moreover, the multi-function optical film of the present invention is capable of scattering the light uniformly and adjusting the directivity of the emitting light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-function optical film, comprising:
a substrate; and
an optical film, disposed on the substrate, the optical film comprising:
a diffusion layer, disposed on the substrate; and
a plurality of micro-protruding structures, disposed on the diffusion layer in an array, wherein the diffusion layer and the micro-protruding structures are formed by mixing a plurality of scattering particles and a transmissive material.

2. The multi-function optical film as claimed in claim 1, wherein a diameter of the micro-protruding structures is smaller than 10 μm.

3. The multi-function optical film as claimed in claim 1, wherein a height of the micro-protruding structures is smaller than 3 μm.

4. The multi-function optical film as claimed in claim 1, wherein the micro-protruding structures are in a shape of cube, cuboid, cylinder, or cone.

5. The multi-function optical film as claimed in claim 1, wherein a material of the scattering particles comprises glass beads.

6. The multi-function optical film as claimed in claim 1, wherein the transmissive material is polymethyl methacrylate (PMMA) or polycarbonate (PC).

7. The multi-function optical film as claimed in claim 1, wherein a material of the substrate is polyethylene terephthalate (PET).

8. A polarizer, comprising:
a first film; and
a plurality of micro-protruding structures, vertically disposed on the first film.

9. The polarizer as claimed in claim 8, wherein the first film comprises:
a protective layer; and
a polarizing body, disposed on one side of the protective layer, wherein the other side of the protective layer is bonded with the micro-protruding structures.

10. The polarizer as claimed in claim 9, wherein the protective layer and the micro-protruding structures are made of the same material.

11. The polarizer as claimed in claim 9, wherein the protective layer, the polarizing body, and the micro-protruding structures are made of the same material.

12. The polarizer as claimed in claim 8, wherein a diameter of the micro-protruding structures is smaller than 5 μm.

13. The polarizer as claimed in claim 8, wherein a height of the micro-protruding structures is smaller than 3 μm.
